(19) United States
(12) Patent Application Publication
(10) Pub. No.: US 2015/0046152 A1
(43) Pub. Date: Feb. 12, 2015

(54) DETERMINING CONCEPT BLOCKS BASED ON CONTEXT

(71) Applicant: QURYON, INC., MOUNTAIN VIEW, CA (US)

(72) Inventor: Woo Joo LEE, Yongin-city (KR)

(21) Appl. No.: 14/452,936

(22) Filed: Aug. 6, 2014

(30) Foreign Application Priority Data
Aug. 8, 2013 (KR) 10-2013-0094205

(51) Int. Cl. G06F 17/27

(52) U.S. Cl. CPC G06F 17/2705; G06F 17/271
USPC 704/9

(57) ABSTRACT

A method for generating a set of concept blocks is presented, wherein the concept blocks are words in a corpus of documents that can be processed to extract trends, build an efficient inverted search index, or generate a summary report of the content. The method entails generating a plurality of target words from the corpus, determining context strings for the target words, obtaining pattern types that are based on number of words and position of words relative to the target words, and assigning weights to each of the context strings having a particular pattern type. The target words are then expressed as vectors that reflect the weights of the context strings. The vectors are compared and grouped into clusters based on similarity. Target words in the resulting clusters are concept blocks. A subgroup of clusters may be selected for another iteration of the process to catch new concept blocks.

CROSS-REFERENCE TO RELATED APPLICATION(S)

This application claims the benefit of Korean Provisional Application No. 10-2013-0094205 filed on Aug. 8, 2013, the content of which is incorporated by reference herein.

### FIELD OF INVENTION

This disclosure relates to extraction of concept blocks based on context.

### BACKGROUND

Today, there is an enormous amount of digital content that is available to individuals and organizations, due to technological developments that facilitate collection and sharing of data. However, the number of hours in a day has not increased to allow people to process the enormous volumes of data. Hence, the value of this data depends largely on the speed and accuracy with which the data can be processed into meaningful and useful information.

Many techniques have been developed to translate the data into valuable information. One of the recent techniques, for example, applies to “trending”-type reports based on what the most commonly-read story is now. This type of “trending” information provides a snapshot of what is currently on the mind of the general public, which may be valuable for various reasons.

Currently available “trending” techniques, however, are somehow limited in that they are based on keeping count of what content is being accessed and what search terms are being received, somewhat mechanically. While reviewing the contents that are being generated and shared continuously would provide valuable information about what the general public (or a specific subgroup of the public) is thinking, the nature of human languages makes it difficult for programs to extract meaningful data from typed content. A method of extracting keywords from natural-language content is desired.

### SUMMARY

A method for generating a set of concept blocks is presented, wherein the concept blocks are words in a corpus of documents that can be processed to extract trends, build an efficient inverted search index, or generate a summary report of the content. The method entails generating a plurality of target words from the corpus, determining context strings for the target words, obtaining pattern types that are based on number of words and position of words relative to the target words, and assigning weights to each of the context strings having a particular pattern type. The target words are then expressed as vectors that reflect the weights of the context strings. The vectors are compared and grouped into clusters based on similarity. Target words in the resulting clusters are concept blocks. A subgroup of clusters may be selected for another iteration of the process to catch new concept blocks.

The corpus may be searched (possibly in real-time) for the concept blocks to identify a trend, such as what is being discussed in the corpus. The corpus may include private content, such as content managed by a social network service.

A syntax parser may be applied to the clusters to extract relations between concept blocks. The relations may reveal valuable information that summarizes parts of the corpus.

Each cluster may be associated with a subject. Relations determined with the syntax parser may be used to identify certain strings as being members of the subject, enabling the generation of a report that lists members and subjects that were discussed in the corpus.

A search index (e.g., an inverted index) may be built using just the target words in the selected subgroup of clusters.

The above applications—the trend identification, subject-member summary generation, and the building of a search index—can be done on private content, such as Social Networking System (SNS) posts without violating account holders' privacy. These applications are neutral as to how the keywords are obtained; there are different techniques for determining keywords in a corpus of documents and clustering or categorizing the keywords. While using the concept block generation technique disclosed herein provides good results, the inventive concept of extracting useful information from private content without violating privacy is not limited to being used with the concept block generation technique.

### BRIEF DESCRIPTION OF THE DRAWINGS

FIG. 1 is a flowchart summarizing a semantic keyword extraction method in accordance with the inventive concept.

FIG. 2 is a flowchart summarizing a context-based data processing method that may be part of the semantic keyword extraction method in accordance with an embodiment of the inventive concept.

FIG. 3 illustrates how the semantic keyword extraction method may be applied to a content to generate keywords for different topics.

FIG. 4 depicts a conventional document access system where users have access to same set of documents.

FIG. 5 depicts an inverted index built from the documents shown in FIG. 4.

FIG. 6 depicts an SNS environment where different users have access to different sets of documents.

FIG. 7 is a block diagram illustrating an exemplary system environment in which the semantic keyword extraction method may operate.

FIG. 8 depicts a block diagram of an exemplary content host that is a social network host.

### DETAILED DESCRIPTION

The present disclosure is now described with reference to a few embodiments as illustrated in the accompanying drawings. In the following description, numerous details are set forth in order to provide a thorough understanding of the present disclosure. However, the inventive concept may be practiced without some or all of the details that are disclosed. Also, well-known processes and/or structures are not described in detail here, in the interest of avoiding obscuring the inventive concept. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure.

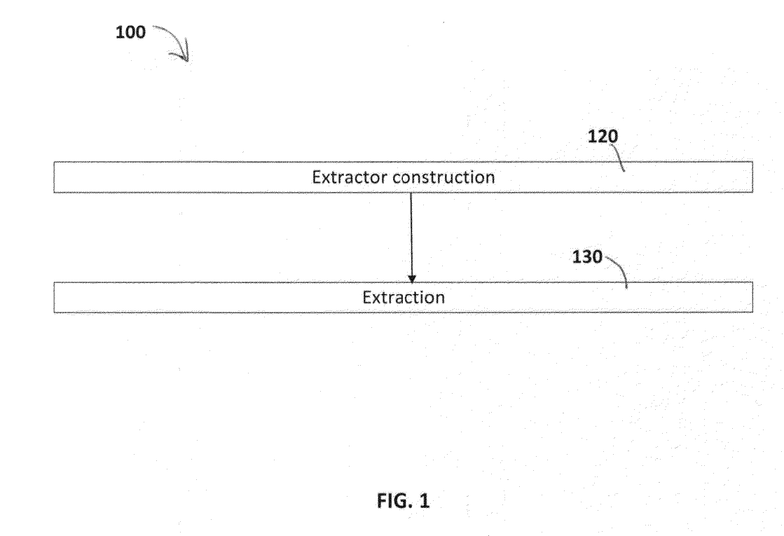

FIG. 1 is a flowchart summarizing a concept block extraction method 100 in accordance with the inventive concept. As shown, the concept block extraction method 100 includes two general stages: extractor construction stage 120, and extraction stage 130. The extractor construction process 120 identifies domain-specific topics. For example, concept block extraction method 100 determines general subjects of discussion such as “law,” “restaurants,” “jobs,” “movies,” “actor,” “director,” “theater,” “author,” “dish,” “interior design,” “travel destination,” and “accountants.” The general subject of discussion is identified by context, as will be described in more detail below. If there is a new word or phrase related to a general subject, the new word will be recognized as a new member pertaining to that subject (e.g., a new book, a new movie, a new legal decision, a new restaurant). Since new subjects (and even new members pertaining to a pre-existing subject) do not surface frequently, extractor construction 120 may be executed periodically, for example every 3 months or 6 months. As used herein, a new “subject matter” refers to both a new subject and a new member associated with a subject.

At completion of the extractor construction process 120, there are sets of target words and accompanying patterns around the target words for each set (or cluster) of target words that may be useful for identifying a new subject and/or a new member pertaining to the subject (or cluster). A human administrator may assign names to some or all of the clusters. Then, in the extraction process 130, contents/documents may be searched to identify the appearance of these target words. The target words that end up in clusters at the end of the extractor construction stage 120 are herein referred to as “concept blocks” because they are string pieces that are useful for identifying a larger subject or topic. The extraction process 130 may be performed in real-time. The extractor construction process 120 is a significantly heavier load than the extraction process 130. Hence, the fact that the extractor construction only runs periodically ensures that the overall performance load applied by the concept block extraction method 100 is not too high.

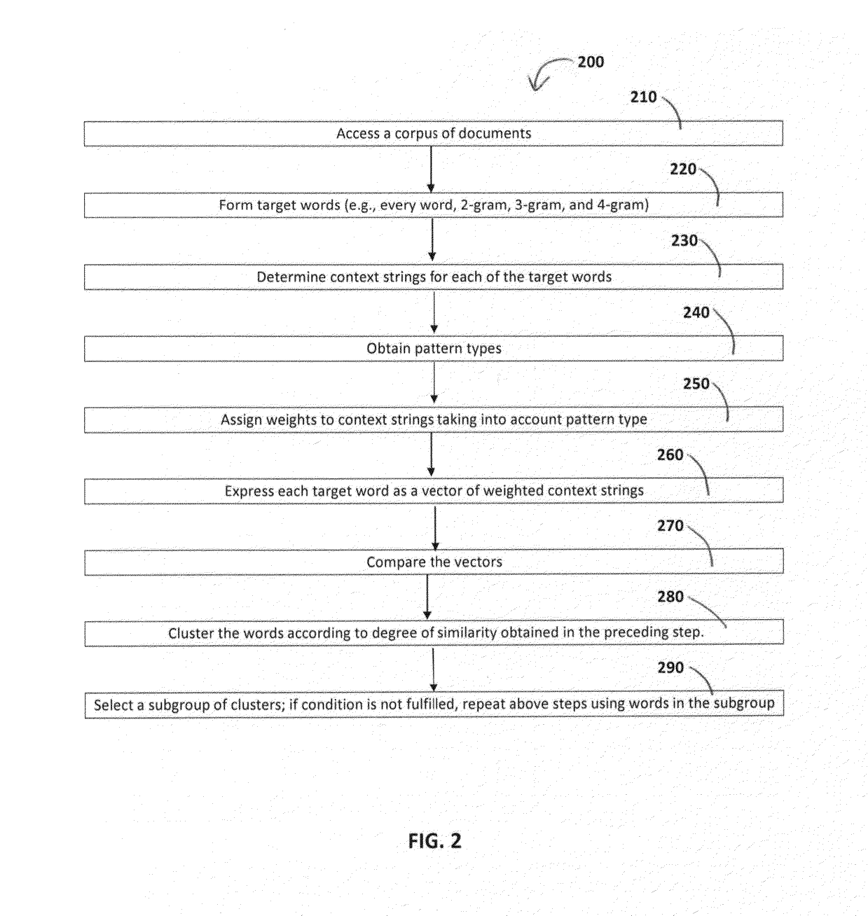

FIG. 2 is a flowchart summarizing a context-based data processing method 200 that may be incorporated into the extractor construction process 120 in accordance with an embodiment of the inventive concept. The context-based data processing method 200 begins with accessing a content that includes one or more documents (210). The “documents” or “content,” as used herein, include strings that include letters, numbers, and punctuation. As used herein, a “corpus” may include a plurality of separate documents or files, which may have been created and/or shared at different times by different individuals, although it may happen to be one document or part of a document. From the content, target words are formed (220). Target words may be individual words (unigrams) or n-gram words (wherein n is an integer, such as 2-gram, 3-gram, 4-gram) and include linguistically non-meaningful units such as “good to read,” “I waited,” “they really enjoy,” or “with my parents.” During this target word formation, single words, as well as 2-gram words, 3-gram words, etc. may be used. In some embodiments, all words in the documents are included in the target word formation, not just syntactically coherent words. For example, phrases like “fun to read” or “they ordered” may be target words.

For each target word, one or more context strings are determined (230). A context string may be one or more words that are adjacent to the target word (e.g. an n-gram word).

The context strings usually fall into certain patterns relative to the target words, based on their length and position relative to the target word. Hence, pattern types are determined (240), whereby the context strings fit into one or more of these pattern types. In one embodiment, each “pattern type” specifies the number of words and their position relative to the target words. For example, where a sentence is wₚ₁wₚ₂wₚ₃W₀wₛ₁wₛ₂wₛ₃ with W₀ being a target word and each of the lower-case “w”s representing strings around it, the following pattern types may be created:
sample pat1=wₚ₃
sample pat2=wₛ₁
sample pat3=wₚ₂wₚ₃
sample pat4=wₛ₁wₛ₂
sample pat5=wₚ₁wₚ₂wₚ₃
sample pat6=wₛ₁wₛ₂wₛ₃
   It should be noted that other pattern types are also possible, and the above list is not intended to be an exhaustive list. Every word and n-gram may be used as context strings, including ones that have overlapping words.

Once the pattern types are determined in step 240, weights are assigned to each context string, grouped according to pattern types (250). The weight is assigned according to frequency of appearance in a certain position relative to the target word. For example, weight may be assigned according to how frequently the pattern appears adjacent to the target word (“adjacent” meaning no intervening word between the target word and the pattern). To determine the weight, a probability-based technique is used in accordance with the inventive concept. Let us suppose, for the sake of illustration, that the following pattern types exist: 1p, 2p, 3p, 1s, 2s, . . . . Pattern type “1p” indicates that a captured string is a single word that precedes the target word, pattern type “2p” indicates that a captured string is a set of two adjacent words that precedes the target word, and pattern type “3p” indicates that a captured string is a set of three adjacent words that precedes the target word. Pattern type “1s” indicates that a captured string is a single word that succeeds the target word, pattern type “2s” indicates that a captured string is a set of two adjacent words that succeeds the tamet word, etc. Some target words may have 1 prefix but cannot have 2 or 3 prefixes because of the position of the target word in the sentence (e.g., if it is the second word in a sentence). The weight of each context string is calculated separately for each pattern type. For example, a weight of the stringwₚ₃ is calculated in 1p mode, weight of wₚ₂wₚ₃ is calculated in 2p mode, and weight of the stringwₛ₁wₛ₂wₛ₃ is calculated in 3s mode.

Pointwise Mutual Information (PMI) may be used to assign weights to patterns. PMI may be calculated as a log ratio of P(W₀)/P(x), wherein P(W₀) is the probability of a particular pattern appearing in the same corpus as target word W₀ and in a designated pattern type, and P(x) is the probability of the particular pattern type x appearing at all in the same corpus.

For example,

$$weight of a context {stringw}_{p 3} for target word {W}_{0} = log \frac{P ( W 0 )}{P ( 1 p )} = log ( \frac{\begin{matrix}probability of the context string appearing in \\ the same content with Wo in pattern type 1 p\end{matrix}}{\begin{matrix}probability of the context string appearing in \\ the same content anywhere in pattern type 1 p\end{matrix}} )$$

$$wherein$$

$$P ( {W}_{0} ) = \frac{\begin{matrix}number of times the context string \\ appears with Wo in pattern type 1 p\end{matrix}}{total number of times pattern type 1 p occurs with Wo} , \\ and$$

$$P ( 1 p ) = \frac{\begin{matrix}number of times the context string \\ appears in the content in pattern type 1 p\end{matrix}}{total number of times pattern type 1 p occurs in the content}$$

$$weight of a context {stringw}_{s 1} {w}_{s 2} {w}_{s 3} for target word {W}_{0} = log \frac{P ( W 0 )}{P ( 3 s )} = log ( \frac{\begin{matrix}probability of the context string appearing \\ in the same content with W 0 in pattern type 3 s\end{matrix}}{\begin{matrix}probability of the context string appearing \\ in the same content anywhere in pattern type 3 s\end{matrix}} )$$

$$wherein$$

$$P ( {W}_{0} ) = \frac{\begin{matrix}number of times the context \\ string appears with Wo in pattern type 3 s\end{matrix}}{total number of times pattern type 3 s occurs with Wo} , \\ and$$

$$P ( 3 s ) = \frac{\begin{matrix}number of times the context string \\ appears in the content in pattern type 3 s\end{matrix}}{total number of times pattern type 3 s occurs in the content} .$$

To further explain the weight assignment technique using PMI, let us suppose there is a corpus of five documents: Doc-1, Doc-2, Doc-3, Doc-4, and Doc-5, each of which consists of the following sentences.
Doc-1: I like pizza.
Doc-2: Pizza was great.
Doc-3: I ordered pizza.
Doc-4: I like pizza, too.
Doc-5: I like pies.
   Setting the target word W₀ to “pizza” and pattern type to 2p, weight for the string “I like” may be calculated as follows.

Numerator of PMI=2/3. The word “pizza” appears 3 times in pattern type 2p (Doc-1; Doc-3, and Doc-4) throughout the corpus. Appearance of the word “pizza” in Doc-2 is excluded because “pizza” being the first word in the sentence, it has no prefix and therefore there is no context string of pattern type 2p.The context string “I like” appears with the target word “pizza” in pattern type 2p twice (Doc-1, Doc-4).

Denominator of PMI=3/6. There are six occurrences of pattern type 2p in the entire corpus (“pizza” in Doc-1, “great” in Doc-2, “pizza” in Doc3, “pizza” and “too” in Doc-4, “pies” in Doc-5). Of the six occurrences of pattern type 2p, the context string “I like” makes up 3 of the occurrences (Doc-1, Doc-4, Doc-5).

So the PMI=log((2/3)/(3/6))=log (1.333)=0.1249

If the content of the corpus had been different, for example had the corpus included Doc-1, Doc-3, Doc-4, Doc-5 and Doc-6 instead of Doc-1, Doc-2, Doc-3, Doc-4 and Doc-5 (so that Doc-2 is replaced by Doc-6), the weight would come out differently. Let us repeat the calculation with the following five documents being in the corpus:
Doc-1: I like pizza.
Doc-3: I ordered pizza.
Doc-4: I like pizza, too.
Doc-5: I like pies.
Doc-6: My parents ordered pizza.
   With this set of documents,
   Numerator of PMI=2/4. The word “pizza” appears 4 times in pattern type 2p (Doc-1, Doc-3, Doc-4, Doc-6) throughout the corpus. Unlike Doc-2, Doc-6 is included in this count because “pizza” is the fourth word in Doc-6 and there is room for a pattern type 2p context string. The context string “I like” appears with the target word “pizza” in pattern type 2p twice (Doc-1, Doc-4), same as in the above example.

Denominator of PMI=3/7. There are seven occurrences of pattern type 2p in the entire corpus (“pizza” in Doc-1, “pizza” in Doc3, “pizza” and “too” in Doc-4, “pies” in Doc-5, “ordered” and “pizza” in Doc-6). Of the seven occurrences, the context string “I like” makes up 3 of the occurrences (Doc-1, Doc-4, Doc-5).

So the PMI=log ((2/4)/(3/7))=log (1.166)=0.066

With weights assigned to each context string, each target word can be expressed as a vector of context strings having different pattern types (260). In one embodiment, each context string is an axis in a multi-dimensional space, and the weight that is assigned to the context strings fitting that pattern type indicates how far the vector extends along that axis. The vector for target word W₀ is herein expressed as something like V₀=(0.1, 0.2, 5.4), while the vectors for target words W₁ and W₂ may be expressed as V₁=(1, 3.5, 4.8) and V₂=(2, 6, 7.8), respectively. Each of the three numbers may be for axes that correspond to context string 1, context string 2, and context string 3. In reality, there will likely be huge set of context strings, and therefore many more than three axes.

The vectors, each of which corresponds to a target word, are then compared (270). Any well-known vector comparison technique, such as cosine similarity, may be used. Any two target words may be compared with each other to generate a single cosine similarity value.

The words are then clustered according to the degree of similarity as indicated in step 270 above (280). Any suitable clustering technique may be used. Many different clusters will be formed in this process, and each cluster will likely include many target words. An example set of clusters may look like the following:
advised: warned, 0.28041 then-told, 0.27787 directed, 0.25254 assured, 0.24406 convinced, 0.19051 informed; 0.17925 aware, 0.17740 quoted, 0.16506 also-gave, 0.15384 tells, 0.14104 carefull, 0.12592 even-gave, 0.12552 then-asked, 0.12161
afternoon: morning, 0.49215 evening, 0.42510 night, 0.31799 mornings, 0.19114 night-around, 0.18138 brunch, 0.14768 nights, 0.14731 evenings, 0.13253
volume: number, 0.12111 amount, 0.11054 size, 0.10823 crowds, 0.10764 majority, 0.10201
usually: normally, 0.33345 typically, 0.32795 generally, 0.32700 always, 0.28912 almost-always, 0.20760
good: great, 0.37813 tasty, 0.30967 decent, 0.30514 pretty-good, 0.22445 very-good, 0.21365 delicious, 0.19041 really-good, 0.18225 nice, 0.18168
whole-experience: overall-experience, 0.48022 rest-of-the-food, 0.46251 entire-staff, 0.30762 food-itself, 0.28952
san-diego : the-bay-area, 0.46535 seattle, 0.44213 tucson, 0.39505 north-scottsdale, 0.32292 san-francisco, 0.30874 hawaii, 0.30073
service: food, 0.31234 patio, 0.25467 burger, 0.12567 pizza, 0.32456, . . .
the-last-time : last-time, 0.48078 the-second-time, 0.32204 the-first-time, 0.27072, . . .
. . .
   wherein the first word in the cluster (shown in bold font) is the target word, and the information following the colon may be other target words and their cosine similarity values. Numerous clustering techniques are known, and any suitable technique may be used (e.g., hierarchical clustering).

Often, there is a large number of clusters at the end of step 280. Of the numerous clusters, a subgroup of clusters is selected. A “subgroup” of clusters is intended to mean at least one cluster. The selection may be made based on a judgment or decision relating to what information would be meaningful and helpful to users, or the relation between certain types of words. For example, from the sample clusters shown above, clusters for “service” and “good” may be selected as words that are likely to be meaningful to users. The selection may be made by a human administrator or by an artificial intelligence program that is capable of changing their internal states based on input(learning).During the selection, names may be attached to the selected clusters, wherein the names indicate the subject of the words in the cluster (e.g., “movie titles,” “book titles,” “director,” “author,” . . . ).

In selecting meaningful clusters from the large number of clusters, the set of clusters may be filtered using a frequency threshold or size threshold (e.g., minimum number of words). Generally, clusters pertaining to meaningful topics tend to be large. Hence, use of frequency filtering or a minimum number of words may help reduce the number of clusters and facilitate the selection of the subgroup of clusters that are likely to be meaningful.

A subgroup of clusters is selected, and the context-based data processing method 200 may be repeated with all the words in the subgroup set as target words (290). The selected clusters are expanded through an iterative process whereby the context words in the cluster are aggregated with each iteration. For example, choosing the “service” cluster and “good” cluster above as target words and running another iteration of the data processing method 200 with the newly set target words may generate a pattern on the original pattern, effectively aggregating the context words.

As many iterations as desired may be performed in this manner. In each subsequent iteration, new words, which were not included in the cluster resulting from the last iteration, may be added to a cluster. With the aggregation of the cluster word set that happens with each iteration, sparse pattern that was not extracted in the previous iteration may be extracted. Sparse target words may be extracted from the newly extracted sparse pattern(s).

At the beginning of each iteration, one cluster of words is substituted for a “target word.” In step 250, the frequency of each cluster's context strings is the sum of the frequencies of the individual context strings in the cluster. Hence, the PMI values may be recalculated from the frequency sum for each cluster. The second time the context-based data processing method 200 is executed, the vector generated in step 260 may be a single-vector representation of all the words that were in one cluster at the end of the previous iteration. After a third iteration, the vector that is generated in step 260 would be a single-vector representation of all the words that were clustered at the end of the second iteration, etc.

Iterations may continue until a predefined condition is fulfilled. The predefined condition may be, for example, the number of newly added words being below x, x being an integer (e.g., 10).

Now, the context-based data processing method 200 will be explained using an example. As mentioned above, a corpus of documents are accessed (210). For simplicity of illustration, let us assume that the corpus of documents includes the following:
I like pizza.
I like California Pizza Kitchen.
If you like BBQ chicken pizza, I recommend California Pizza Kitchen.
I frequently go to California Pizza Kitchen for lunch.
Pizza is my favorite lunch food.
They ordered pizza from California Pizza Kitchen for the lunch meeting.
California Pizza Kitchen is more crowded for lunch than Nicolino's.
I never go to California Pizza Kitchen for lunch.
California Pizza Kitchen is good but not great.
The drinks at California Pizza Kitchen are also good.
I thought the pina colada at California Pizza Kitchen was surprisingly good.
There is nothing like pizza and beer after a hard day.
It is fun to read customer reviews on pizzerias.
What percentage of California Pizza Kitchens that are in the state of California are in the Bay Area?
Last Friday's dinner at California Pizza Kitchen was indeed fabulous.

Target words may include the following:
W0=California
W1=pizza
W2=kitchen
W3=good
W4=also good
W5=fabulous
W6=indeed fabulous
W7=Bay Area
W8=fun to read
W9=they ordered
   The above list is not an exhaustive list of target words, as each word in the document and each n-gram may be a target word. Two-word phrases like “also good,” “indeed fabulous,” “Bay Area,” and “they ordered” may be considered as 2-gram words. Phrases like “fun to read” may be 3-gram words. Target words are formed based on the arrangement and sequence of strings (including letters, numbers, and punctuations), not based on any semantic meaningfulness or syntactic coherence. The method can be used without using a syntax parser or morphologic analyzer.

During the determination of context words, adjacent words and random n-grams may be selected. For example, for target word W1 (“pizza”), context strings may include “I like,” “for lunch,” “ordered,” “like California,” “I like California,” “kitchen,” “is my favorite,” and “is my.” These context strings are then grouped according to their pattern types. One word may be patterned multiple times, as overlap will happen—for example, “is my favorite” and “is my” may be separate context strings with different pattern types even though one is part of the other. In an example where context string 1=“I like,” context string 2=“for lunch,” and context string 3=“ordered,” the weights for the three context strings may be 0.32, 0.25, and 0.14, respectively, based on the PMI formula provided above. After the weights are assigned to each context string, they are mapped to a multi-axes space, wherein one context string is mapped to one axis. Values 0.32, 0.25, and 0.14 will be mapped along three axes (each axis being for context string 1, context string 2, and context string 3) to obtain the vector V₁ that represents the target word W₁.

Comparing target words using a technique such as cosine similarity, the closeness of two target words may be represented as a single numerical value, as in the examples below:
pizza & ice cream=0.5
pizza & California=0.08
pizza & I like=0.01
ice cream & California=0.08
ice cream & I like=0.005
   The similarity values above, in one aspect, indicate how often the two target words being compared appear surrounded by the same set of context strings.

At the end of the iterative process (the extractor construction stage 120), there are three outputs: clusters of target words (concept blocks), a subject assigned to each of the clusters, and context strings associated with each cluster. The concept blocks may be used as keywords for some of the applications described below. Alternatively, based on the concept blocks, a human administrator or an AI program may come up with a smaller set of “keywords” that is better suited for the exact application.

During or after the extraction process 130, common context strings associated with the clusters of target words (concept blocks) may be identified. As shown in FIG. 1, the extraction process 130 follows the extractor construction 120, which includes the iterative data processing method 200. The details of the extraction process 130 may depend on the application.

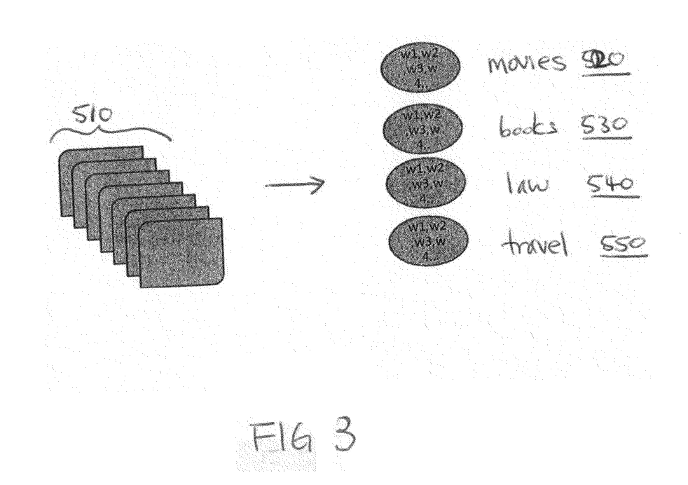

In one application, the results may be summarized in a report that shows the name of the restaurant and frequently-appearing description of it (“excellent,” “pretty good,” “tasty,” “delicious”). FIG. 3 illustrates how the semantic keyword extraction method 100 may be applied to a corpus of documents 510 to generate concept blocks affiliated with different subjects, such as movies 520, books 530, law 540, and travel destinations 550. A syntactic parser may be utilized to determine relations between clusters, extracting the general concepts that are discussed in the corpus. For example, the following syntactic relation may be used:

<Subject>&<Verb, including “be+adjective”> or

<Adjective>+<Noun>.

The syntactic parser may be applied to the “service” cluster and the “good” cluster to produce a set of meaningful strings, such as “service is good,” “service was terrible,” or “food was excellent.” Applying the syntactic parser to the clusters formed from the context-based data processing method 200 allows the generation of a concept summary with relational sentences.

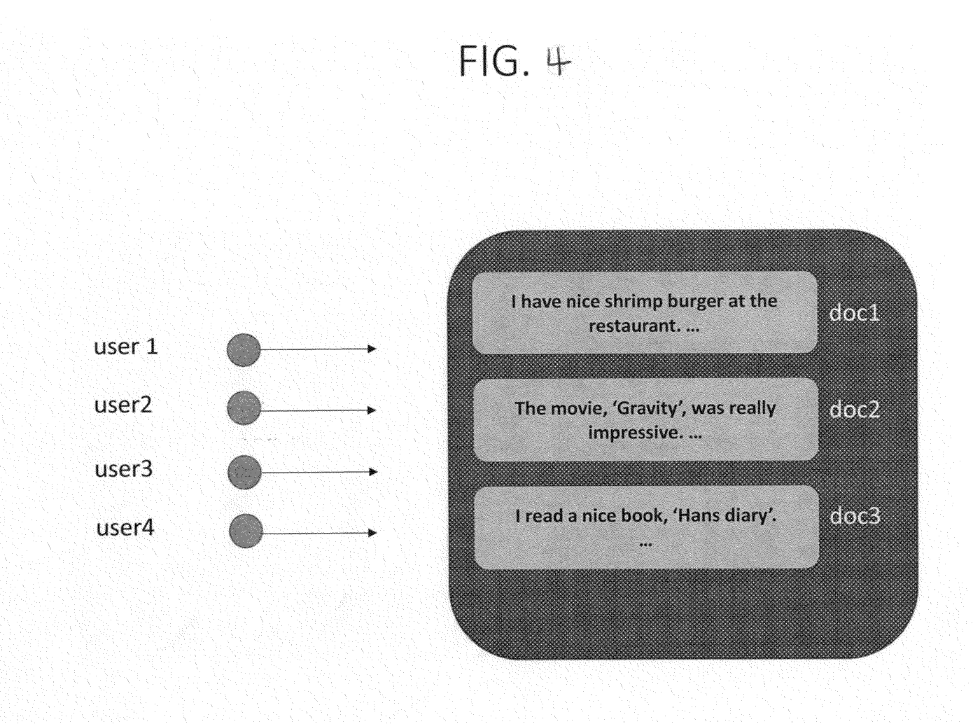

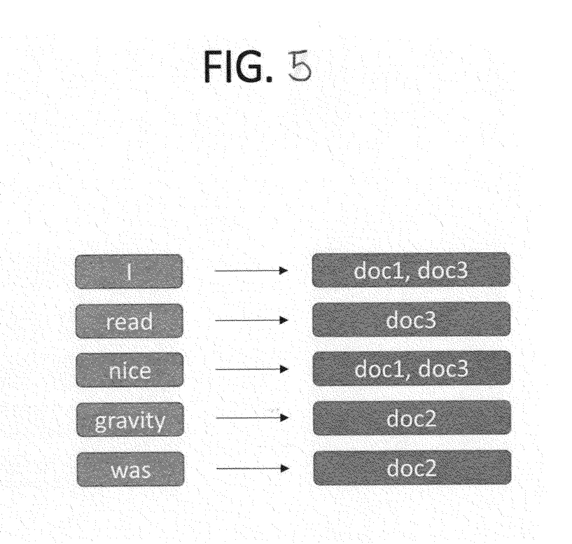

In another application, the method 200 may be used to build a search index. In a general search system, users view or have access to the same set of documents. For simplicity of illustration, FIG. 4 shows users 1, 2, 3, and 4 viewing doc1, doc 2, and doc3. Conducting a search through the corpus of documents usually entails building a search index. A search index is an inverted index that maps content to source/location, or each of the words to the documents in which they appear. FIG. 5 depicts an inverted index built from the corpus of documents shown in FIG. 4.

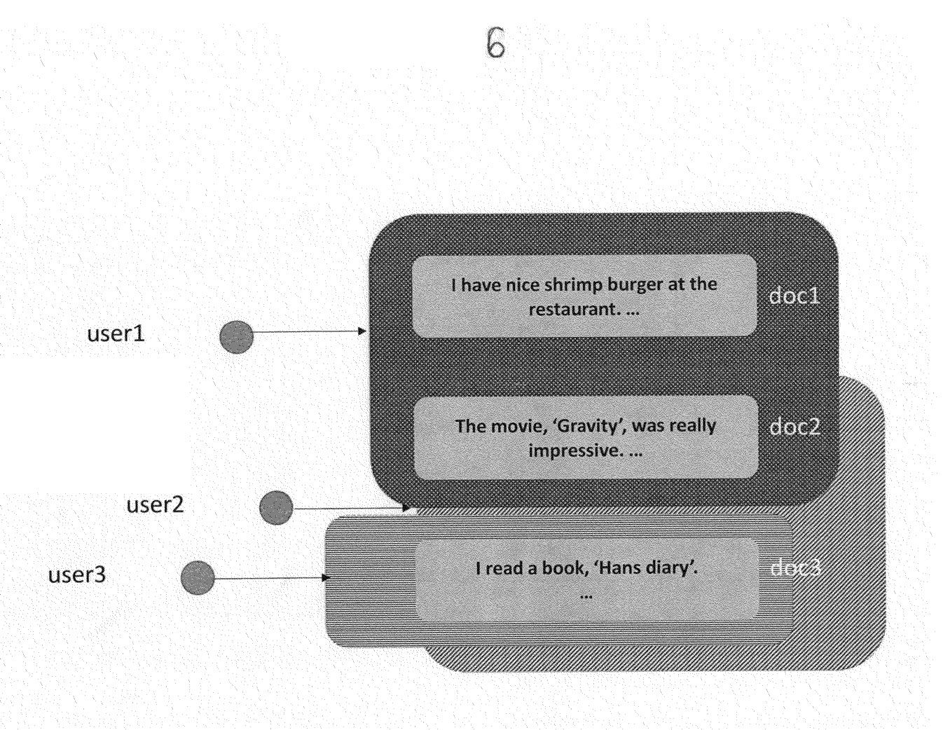

Building a search index in an SNS environment is challenging because different users view different contents. In other words, each user may have a unique corpus of documents. For example, in a SNS such as Facebook® or Linkedin®, user 1 may see different newsfeeds than user 2, with access to different contents although there may be some overlap. FIG. 6 visually illustrates this situation, and shows the corpus of documents for user 1 being doc1 and doc2, the corpus of documents for user 2 being doc2 and doc3, and the corpus of documents for user 3 being doc3. Building a search index would, in this situation, entail building a separate search index for each user, which would be so burdensome and inefficient, perhaps to the level of being prohibitive.

In the search index application in accordance with the invention, extractor construction 120 does not need to be done for each user separately. Rather, the extractor construction process 120 may be applied to multiple users' SNS posts as one big corpus. After obtaining global clusters of target words in the entire corpus, each of the clusters is associated with a subject and a set of context strings. The subject, as explained above, may be assigned by an administrator. With this global output, multiple users' contents (including private contents) that make up the corpus can be distilled down to a set of meaningful and informative concept blocks.

These concept blocks may then be used to build an inverted index for each user. This function would allow a user to enter a query word and efficiently find the posts that contain the query word. While extraction may be performed for the whole corpus, a separate search index can be built for each user. During the building of an inverted index, stop words such as “I,” “the,” or “was” may be removed as being of relatively little semantic significance. With the context-based data processing method 200, the size of the inverted index can be made much smaller than in the general case where each word is mapped. This significantly reduced inverted index makes a search system for SNS environment a possibility.

In yet another application, the context-based data processing method 200 may be used by SNS users to organize and summarize the volumes of content that is available to each of them. More specifically, the target word clusters may be used to classify, summarize, and organize the document content. For example, let's suppose that user 1 is a user of an SNS such as Facebook®, he has a lot of friends, and many of his friends post or share actively. A lot of data can flow into the message box of user 1. Unless user 1 is actively and continually checking his Facebook® page, he might miss a lot of content. Furthermore, he might forget about some content that he quickly glanced at in the parking lot on the way to his car.

The context-based data processing method 200 may be used by user 1 to organize and summarize the content that is in his message box. For example, by executing a function or an application that triggers the context-based data processing method 200, user 1 may be able to generate a summary such as follows:
Book: Hans' Diary, Game of Thrones, Invisible
Restaurants: California Pizza Kitchen, Alexander's, Ramen House
Movies: Gravity, Transformer, Hercules

In this application, an SNS user can search his SNS content by subject (Movies) and get a list of words in return. As mentioned above, a subject is assigned to each of the target word clusters at the end of the extractor construction process 120, and common context strings may be associated with target words. With these data, each user can query a subject and find summary information about the subject. For example, he may enter “Restaurants” to obtain “California Pizza Kitchen, Alexander's, Ramen House, . . . , ” all or some of which may have been discussed somewhere in his friend's content. This can be done even if the friend's content is not public. He may then query “Movie” to obtain “Gravity”, “Frozen” . . . This type of subject-based search is made possible by grouping words of a corpus and determining relations between the groups, as explained above.

The subject for each cluster may be assigned by a human administrator or an artificial intelligence program. Looking at the words in a cluster, a human administrator or an AI program will be able to determine whether the subject is “food,” “restaurants,” “book,” etc. If a new member appears for the subject (i.e., a word or phrase that was not previously found in discussions of this general topic), such as a new restaurant or a new book, the context-based data processing method 200 is able to identify it. When words are clustered, words in the same cluster are generally words that appear in the same context. Based on the context, it is possible to categorize the discussion into general subjects such as “food,” “law,” “accounting,” “books,” etc. For example, if the word “Frozen” repeatedly appears around context strings that indicate the subject Movie, it will be determined that “Frozen” is a new member of the subject category Movie (i.e., it is a new movie).

The subject-member summary may be used by an SNS user to get a quick glance at what is discussed in his posts. In some implementations, the summary may indicate whether each subject and/or each member was mentioned in a post that the user read or a post that the user did not read.

As will be described in more detail below, one of the applications of the semantic keyword extraction method 100 is with Social Networking System (SNS) sites. Today, there are services that provide “trending” data based on publically available information such as search terms. As search terms entered into search engines are not private, trending search terms is unlikely to raise any privacy-related concerns. One of the advantages of the conceptual token extraction method 100 is that it allows private and public sites to be accessed for the extractor construction process 120 and the extraction process 130. Then, without publishing any private information or content, a summary of new subjects that are discussed by many users in the private sites may be aggregated and made available. In effect, the conceptual token extraction method 100 allows “trending” to be performed (e.g., perhaps even in real-time) on various sites by counting or otherwise maintaining some type of statistical data on the keywords. This trend data about generally what SNS users are interested in may be shared with third parties.

It should be noted that the above applications to SNS sites—such as the subject-member summary, the inverted index, and the trending of discussions happening in private SNS accounts—are not limited to being done with the context-based data processing method 200. There are other known methods and databases of keywords, as well as techniques for grouping or clustering those keywords. In some cases, keywords may be organized by category and stored in a data storage. Regardless of how the keywords are determined and organized, the inventive concept pertains to using those keywords to extract useful information from SNS posts and/or other private content without violating user privacy.

As mentioned above, in one implementation, the context-based data processing method 200 may be used to extract information from Social Networking System (SNS) sites. One of the advantages of the context-based data processing method 200 is that it is able to extract useful information without disclosing private data or actual content. This aspect of the method 200 makes it suitable to be used with SNS sites. One of the challenges presented by SNS sites is that unlike other types of online publication, different users have different contents on their sites. For example, while both user 1 and user 2 may be users of the same SNS site, each of them will see different content when s/he logs in because they have different affiliations and preferences. The context-based data processing method 200 is capable of crawling through the content of a desired group of users to extract new concepts that are being discussed in that group.

An SNS will now be generally described as one possible application of the semantic keyword extraction method 100. An SNS site enables its users to perform various types of actions through its web-based interface. For example, a user of an SNS may search for other users of the SNS, create a private circle and select individual users to be included in the circle, communicate with other users, post messages and photos, organize social gatherings, receive news feeds, use social applications, etc. The summary report generation function described above could be implemented as an action. In particular embodiments, each time a user performs an action at or in connection with a SNS, the corresponding system may record the action. Consequently, the SNS may function as a repository of many actions performed by different users at different times.

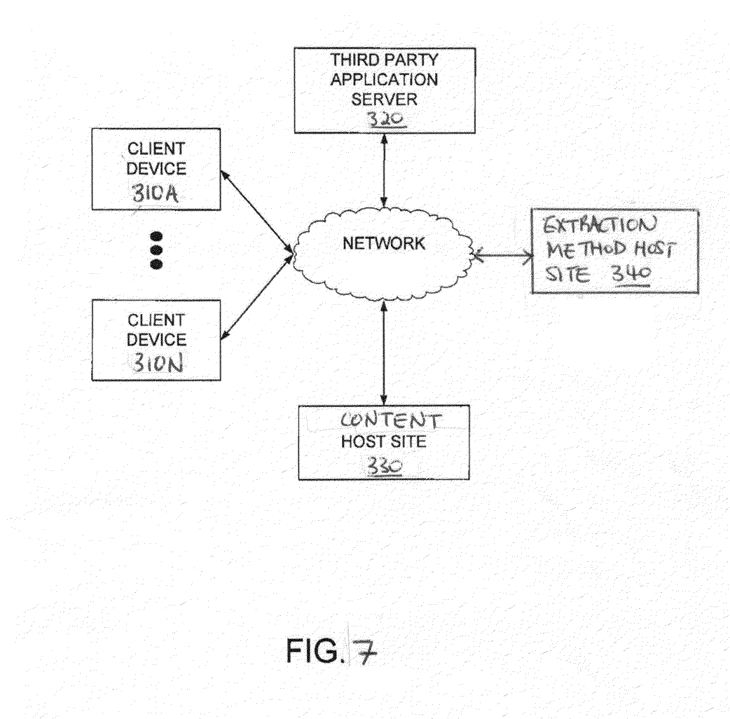

FIG. 7 is a block diagram illustrating an exemplary system environment (e.g., Facebook®) in which the semantic keyword extraction method 100 may operate. The system environment that is shown includes one or more client devices 310A-N, a third-party application server 320, a content host site 330, an extraction method host site 340, and a network. The content host site 330 may be a social network host site, although this is not a limitation of the inventive concept. In other embodiments, different and/or additional modules may be included in the system.

The client devices 310A-N may be devices that transmit and/or receive data via the network and receive user input. For example, a client device 310A may be a desktop computer, a laptop, smartphone, a personal digital assistant (PDA), a mobile computing device, a tablet, or any other device including a processor, memory, and data communication capabilities.

A third-party applications server 320 includes a source, such as a computing device or a virtual machine that is associated with one or more identifiers, such as a single DNS entry or related DNS entries. The third-party application server 320 communicates or shares data, information or services with client devices 310 and the content host site 330 via the network responsive to requests by a client device 310A or by the content host site 330. For example, the third-party application server 320 may receive data from a client device 310A via the network, process the received data, and transmit output data back to the client device 310A via the network. The third-party application server 320 provides applications that are configured to execute within the host site's runtime environment, and may include applications for online sales, online auctions, gift giving, meetings, event management, discussion boards or other applications that provide data or other information to a client device 310 through the network.

Applications provided by the third-party application server 320 provide enhanced content and interactivity within the content host 330. Where the content host 330 is a social network host, the third-party application server 320 may maintain an application object for each application hosted in the content website. An example application is an enhanced messaging service in which users can send virtual gifts and an optional message to another user. Applications may be written as server-side code that is run on the third-party application server 320, although they may use client-side code at times.

The content host 330 includes a computing system that allows one or more members to interact with each other using the network. For example, the content host 330 stores data, such as user profiles or user preferences, describing members of the content host 330. To be a member, one may be required to register and open an account with the content host 330. The content host 330 may also store information about relationships between members. For example, member A may be part of member B's circle of closer friends, or member A may be a co-worker or ex-co-worker of member B, and these relationships would be stored by the social network host 103. The content host 330 provides various mechanisms by which members can communicate with each other.

The content host 330 maintains a user profile for each member. Any action that a particular member takes with respect to another member is associated with each member's profile, through information maintained in a database or other data repository. Such actions may include, for example, adding a connection to the other member, sending a message to the other member, reading a message from the other member, viewing content associated with the other member, attending an event posted by another member, among others. In addition, a number of actions described below in connection with other objects are directed at particular members, so these actions are associated with those members as well.

The user profiles also describe characteristics, such as work experience, educational history, hobbies or preferences, location or similar data, of various users and includes data describing one or more relationships between users, such as data indicating users having similar or common work experience, hobbies or educational history.

The content host 330 may allow different users to communicate with one or more additional members using the network.

The network may be any combination of local area and/or wide area networks, using both wired and wireless communication systems. Alternatively, the network may be replaced by a peer-to-peer configuration where the client devices 310, third-party application server 320 and content host 330 directly communicate with each other.

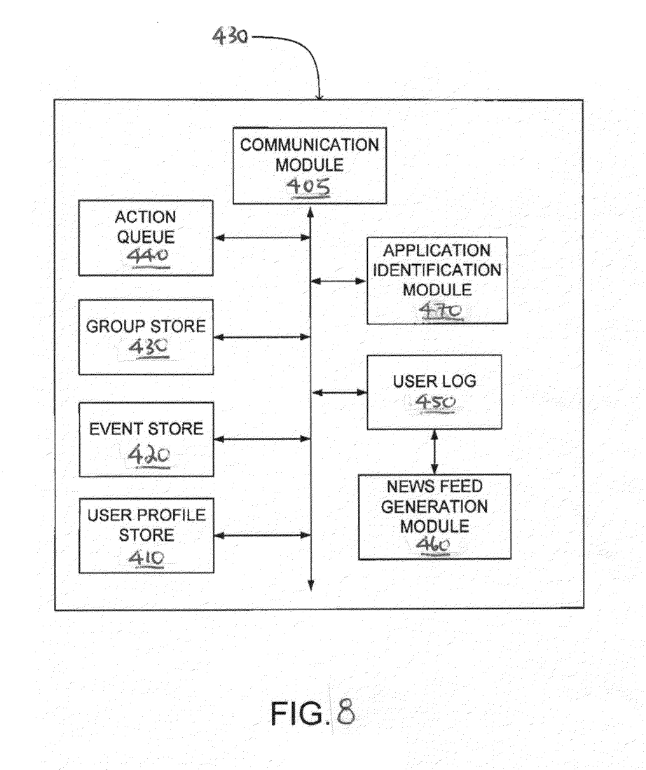

FIG. 8 depicts a block diagram of an example content host that is a social network host 430. As shown, the social network host 430 includes a communication module 405, a user profile store 410, an event store 420, a group store 430, an action log 440, a user log 450, a news-feed generation module 460 and an application identification module 470. In other embodiments, the social network host 430 includes different and/or additional modules, or some shown module may be omitted.

The communication module 405 links the social network host 430 to the network, or to one or more client devices 310 and/or third-party application servers 120. The communication module 405 is a network interface which supports a networking protocol stack, such as the Open Systems Interconnection Basic Reference Model (OSI Model). Hence, the communication module 405 allows the social network host website 430 to communicate with the network using wireless and/or wired communication methods.

The user profile store 410 includes data associated with different users of the content host 330. When a user requests access to a service provided by the content host 330, a user profile is generated for that user and stored in the user profile store 410. The user profile includes data describing one or more characteristics associated with the user, such as demographic information, geographic location, educational history, employment status, employment history, interests and hobbies, etc. A user profile also includes privacy settings indicating how accessible his user profile is to other users, user contact information or user-defined relationships with other users, such as the user's friends, networks, groups, or the like. The user profile store 410 can organize the stored user profiles by a social networking identifier, which is used to uniquely identify users of the social network host 430.

The event store 420 includes data describing various events that occur outside of the social network host 430. For example, the event store 420 includes data describing a concert, movie, meeting or other physical event that occurs in the real world, events occurring within the social network host site, or in any other online site. The event store 420 includes data describing the name of the event, an event start and end time, an event location (e.g., a city or a website), a list of users attending the event or other descriptive data. Additionally, the event store 420 can include data or information summarizing the event after it ends, such as photos, videos, reviews or a discussion board associated with the event. The event store 420 can communicate with the user profile store 410, allowing users to be associated with events. The event store 420 can organize the stored event data according to an event identifier which uniquely identifies each stored event.

The action log 440 includes data describing various actions taken by users within the social network host 430. The stored actions can occur within the social network host 430 as well as other sites, via an application programming interface (API) exposed by the social network host 430. In one embodiment, the social network host 430 maintains the action log as a database of entries. When an action is taken on the social network host site 430, an entry for that action is added to the action log. Examples of user actions within the social network include sending a message to a friend, using a third-party application, joining a group, leaving a group, adding a relationship to another user, removing a relationship to another user, modifying a stored user profile, generating an event description or other modification or retrieval of data stored by the social network host 430. The action log 440 includes data describing the user performing the action, the time the action took place, an identifier for the user who performed the action, an identifier for the member to whom the action was directed, an identifier for the type of action performed, an identifier for an object acted on by the action (e.g., an application), content associated with the action, where the action occurred and/or other data describing the action.

It can be appreciated that many types of actions that are possible in the social network host 430 need not require all of this information. For example, if a member changes a picture associated with the member's profile, the action may be logged with just the member's identifier, an action type defining a picture change, and the picture or a link thereto as the content. The action log 440 can communicate with the user profile store 410, event store 420 and/or the group store 430 allowing events, users and/or groups to be associated with an action. The action log 440 can organize the stored action data according to an action identifier which uniquely identifies each stored action. The action log 440 can store actions based on when the action occurred. In one embodiment, the action log 440 may use a last-in, first-out (LIFO) log structure to store actions so that the most recent actions are retrieved from the action log 440 first. In another embodiment, a single action log 440 stores actions from all of the social network host 430 users and organizes the stored actions according to user identifiers or partitions the action log to allocate storage for different users. Alternatively, the social network host 430 includes multiple action logs 440 associated with different subsets of the user population, such as by affiliation, group, geography, or the like.

For each user, a user log 450 is maintained based on actions extracted from the action log 450. A given user's log 450 includes data from the action log 440 describing user actions, and can include additional data from the user profile store 410, even stores 420 and/or group store 430 that is associated with or affected by the action, to further annotate or tag the action data. The user log 450 can organize the action and related data chronologically, allowing the user log 450 to record the sequence in which actions were performed by the user and allowing easier access to more recent user actions.

The news-feed generator 460 is adapted to communicate with the user log 450 and generates, for each user, a news-feed comprising one or more stories, based on the content of the user log 450 associated with a particular user. A story is a message that summarizes, condenses, or abstracts one or more actions from the user's log 450. The generated news-feed stories can then be transmitted to one or more related users—e.g., the user's friends—allowing the user's actions to be shared with such related users. The news-feed generator 460 applies an affinity algorithm to the contents of the user log 450 accounting for a user's relationships with other users or groups as specified in the user profile store 410 and/or group store 430 to select the actions in the log 450 that are to be the basis of one or more stories for distribution to the related users. By accounting for the user relationships with other users and/or groups, the news-feed generator 460 determines data from the user log 450 most relevant to other related users.

The semantic keyword extraction method 100 may be executed on select content hosted by the social network host site 430, and the parameters may be set based on information in the user profile store 410. For example, if one is interested in knowing what users in the state of California are talking about, geographic information in the user profile store 410 may be used to limit the scope of the method 100 to just the content of users who submitted a California address. Various other data stored by the social network host 430 may be used to limit the breadth of keyword extraction.

The conceptual token extraction method 100 may also be used by the users of the social network host 430. For example, if a user is connected to a large circle of other users and cannot read all the content that is made available to him, he can use the conceptual token extraction method 100 to obtain a summary of what is in his own content. For example, he can check for new titles in the “book” category or get a sense of what people are doing for “spring break” without individually going through every post that was made available to him. The conceptual token extraction method 100 will look through not only the posts that the user has already read but also ones that have not been read.

Various embodiments of the present disclosure, such as the servers, hosts, and client devices, may be implemented in or involve one or more computer systems. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present disclosure, the memory may store software for implementing various embodiments of the present disclosure.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present disclosure, the storage may store instructions for the software implementing various embodiments of the present disclosure. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present disclosure, operating system software may provide an operating environment for software's executing in the computer system, and may coordinate activities of the components of the computer system.

Various embodiments of the inventive concept disclosed herein may be described in the general context of computer-readable media. Computer-readable media are any available media that may be accessed within a computer system. By way of example, and not limitation, within the computer system, computer-readable media include memory, storage, communication media, and combinations thereof

Having described and illustrated the principles of the inventive concept with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the inventive concept are described and illustrated herein, it will be appreciated that they are merely illustrative.

What is claimed is:

1. A method of generating a set of concept blocks, the method comprising:
accessing a corpus of documents;
generating a plurality of target words from the corpus;
determining context strings for the target words, wherein the context strings include words that are adjacent to the target words;
obtaining pattern types, wherein the pattern types are based on number of words and position of words relative to the target words;
assigning weights to each of the context strings, such that a weight of a context string having a particular
$$pattern type = log \frac{P ( W 0 )}{P ( x )} , \\ wherein$$
$$P ( {W}_{0} ) = \frac{\begin{matrix}number of times the context string \\ appears with Wo in pattern type x\end{matrix}}{total number of times pattern type x occurs with Wo}$$
$$and$$
$$P ( x ) = \frac{\begin{matrix}number of times the context string \\ appears in the corpus in pattern type x\end{matrix}}{total number of times pattern type x occurs in the corpus}$$
expressing the target words as vectors of weighted context strings;
comparing the vectors to obtain a similarity measure;
grouping target words into a plurality of clusters according to their similarity measures; and
selecting a subgroup of the clusters, wherein target words in the selected one of the clusters are concept blocks.

2. The method of claim 1, wherein the selecting of the subgroup of clusters comprises filtering the clusters based on at least one of frequency threshold and size threshold.

3. The method of claim 1 further comprising expanding words in the subgroup of the clusters by aggregating context strings for the subgroup of clusters.

4. The method of claim 3, wherein the selected subgroup of clusters are original subgroup of clusters, and expanding the selected subgroup of clusters comprises:
setting the concept blocks as a new set of target words;
assigning weights to context strings for the new set of target words;
generating a clustered vector by expressing the new set of target words as a single vector; and
comparing the clustered vector against another clustered vector to produce a set of new clusters based on similarity.

5. The method of claim 4 further comprising extracting sparse words from the new clusters, wherein the sparse words were not present in the original subgroup of clusters.

6. The method of claim 1 further comprising generating target words using n-grams in the content, n being an integer.

7. The method of claim 6, wherein n-grams include at least one of unigram, 2-gram, 3-gram, and 4-gram sequences of words.

8. The method of claim 1, wherein context words include semantically significant words and semantically insignificant words.

9. The method of claim 1 wherein the pattern types comprise overlaps such that two pattern types may include the same string.

10. The method of claim 1, wherein expressing the target words as vectors comprises mapping the context strings on a multi-axis space, wherein one axis corresponds to one context string.

11. The method of claim 1, wherein comparing the vectors to obtain a similarity measure comprises comparing cosine similarity measures.

12. The method of claim 1 further comprising syntactically parsing the words in the plurality of clusters to identify a relation between clusters.

13. The method of claim 12 further comprising:
associating each of the clusters in the subgroup with a subject; and
generating a summary including subjects and members associated with the subjects based on the relation between clusters.

14. The method of claim 1 wherein the documents include SNS posts, further comprising generating keywords based on the concept blocks.

15. The method of claim 14 further comprising extracting keywords from documents that are associated with an individual SNS user account to generate a summary report including subjects of discussion and members of the subjects.

16. The method of claim 15 further comprising indicating in the summary report whether each subject and each member is found in a post that has already been viewed or an unviewed post.

17. The method of claim 14 further comprising building a search index using the keywords for the individual SNS user account, wherein the search index includes an inverted index that is configured to identify one or more posts containing discussions related to a query word.

18. The method of claim 14 further comprising:
extracting keywords from the corpus of documents; and
counting occurrences of some or all of the keywords to determine a trend based on the occurrences.

19. The method of claim 18 further comprising providing information about the trend to a third party.

20. A method of generating a summary of discussions in SNS posts, comprising:
obtaining a categorically arranged set of keywords from a data storage;
identifying occurrences of the keywords in posts that are associated with an SNS user account; and
arranging the identified keywords according to their categories to generate a summary report including subjects of discussion and members of the subjects.

21. The method of claim 20 further comprising indicating in the summary report whether each subject and each member is found in a post that has already been viewed or an unviewed post.

22. The method of claim 20 further comprising building a search index for the individual SNS user account, wherein the search index includes an inverted index that is configured to identify one or more posts containing discussions related to a keyword.

23. The method of claim 20 further comprising counting occurrences of some or all of the keywords to determine a trend based on the occurrences.

24. The method of claim 23 further comprising providing information about the trend to a third party.

25. A method of generating a set of keywords, the method comprising:
accessing a corpus of documents;
generating target words from the corpus of documents;
determining context strings for the target words, wherein the context strings include words that are adjacent to the target words;
obtaining pattern types, wherein the pattern types are based on number of words and position of words relative to the target words;
assigning weights to each of the context strings, such that a weight of a context string having a particular
$$pattern type = log \frac{P ( W 0 )}{P ( x )} , \\ wherein$$
$$P ( {W}_{0} ) = \frac{\begin{matrix}number of times the context string \\ appears with Wo in pattern type x\end{matrix}}{total number of times pattern type x occurs with Wo} , \\ and$$
$$P ( x ) = \frac{\begin{matrix}number of times the context string \\ appears in the corpus in pattern type x\end{matrix}}{total number of times pattern type x occurs in the corpus} ;$$
expressing the target words as vectors of weighted context strings; and
generating keywords rising the vectors.
